(19) United States
(12) Patent Application Publication
(10) Pub. No.: US 2003/0139993 A1
(43) Pub. Date: Jul. 24, 2003

(54) Method and device for calculating value at risk

(76) Inventor: Andrey Feuerverger, Toronto (CA)

Correspondence Address: The Law Office of Richard W James, 25 Churchill Road, Churchill, PA, 15235, US

(21) Appl. No.: 10/240,333

(22) PCT Filed: Mar. 28, 2001
(86) PCT No.: PCT/CA01/00418

(51) Int. Cl. G06F 17/60

(52) U.S. Cl. 705/36

(57) ABSTRACT

The invention is a method and system for determining VaR. The invention does not require Monte Carlo sampling. Alternatively, if Monte Carlo sampling is used, it requires only a reduced number of such trials. The invention is based on reducing the pricing function of the overall portfolio to a delta-gamma approximaiton, which in effect is a quadratic form in the risk factors; the distribution of the risk factors is, in turn, assumed to be a known multivariate normal distribution; the distribution of this quadratic form in normal variables is then determined by means of first evaluating the moment generating function (Laplace transform) of this distribution, and then applying highlt accurate methods of saddlepoint approximation to this moment generating function to determine the distribution and its quantiles.

### FIELD OF THE INVENTION

This invention relates to a method and system for determination of the value at risk (VaR) in possessing a portfolio of holdings over a given period of time.

### BACKGROUND OF THE INVENTION

Accurate determination of the value at risk (VaR) in holding a specified portfolio over a given period of time is a significant problem in modem financial applications. Financial institutions and companies, such as banks, are often required by law, by regulation, or by internal accounting requirements, to determine the amount of money which is at risk (due to market fluctuations) over a given period of time (such as a day or a month), and to report this quantity (for example to regulatory agencies), and to maintain cash reserves deemed adequate to cover such potential market losses. The term Value at Risk, often written as VaR, refers most generally to the statistical distribution of market losses (or gains) that will be experienced by a portfolio of financial instruments held over a given period of time. In this respect, Value at Risk is in fact a random quantity whose statistical properties are determined by the statistical properties of the underlying financial markets. More specifically, however, the term VaR is often taken to mean a specific given percentile of that statistical distribution, such as the lower 1% point, or the lower 5% point of that distribution. Thus, for example, the VaR based on the lower 5^{th} percentile (a common choice in practice) represents that dollar value of losses that the portfolio will lose only one time out of 20. (Thus 19 times out of 20 the losses incurred will be less that this VaR amount, while once in 20 times the losses will exceed this amount.)

Current methods of determining VaR are based on assessment of the statistical behavior of a collection of risk factors (typically prices), such as bond prices, equity prices, commodity prices, foreign exchange rates, interest rates, etc., that vary day to day (month to month, or over other given time intervals). In analytical work it is common to assume that the vector of risk factors has a multivariate normal distribution. More specifically, it is usual to work with returns rather than with prices. A return, over a given period of time, is the fractional (or percentage) change in price that has occurred. (Alternately, it is possible to work with logarithmic returns which are defined as the change in value of the logarithm of the price over the given interval of time; usually these definitions of return are approximately equivalent.) It is the vector of risk factor returns that is assumed to have a multivariate normal distribution. The mean of this distribution is usually taken to be a vector of zeros, due to the generally short time periods intended for VaR computations. These risk factor returns are thus typically described by means of a variance-covariance matrix that indicates how each risk factor individually varies, and how each risk factor is correlated with the other risk factors in the collection. The variance-covariance matrix is difficult to determine, in part because the nature of market volatility changes over time; often such variance-covariance data is supplied by companies that determine such data.

Current practice in this area, and much relevant technical background is summarized, for example, in the widely cited RiskMetrics Technical Document published by J. P. Morgan/Reuters (1996). For typical portfolios held by large financial institutions, such work is typically carried out by methods involving Monte Carlo trials. The Monte Carlo method involves generating artificial days (scenarios) with variation that attempts to mimic the anticipated variation of the risk factors. A large number of such scenarios must be generated, and the portfolio must correspondingly be reevaluated (i.e. priced) an equally large number of times to ensure statistical reliability of this method.

Such computations are cumbersome, and are time and resource consuming. Furthermore, the accuracy of the Monte Carlo method is typically limited to order of the inverse square root of the number of trials performed. The purpose of this invention is to provide a method for carrying out such computations more accurately, more quickly, more conveniently, and without the need to rely upon Monte Carlo trials, or with substantially reduced reliance upon Monte Carlo trials.

The technical problem may be described mathematically as follows. Let X=(X₁, . . . , Xₖ)′ be a (column) vector of random variables representing the returns, over the single interval of time considered, for the k underlying securities, market indices, risk factors, and other variables (hereafter collectively referred to as risk factors) comprising our ‘universal basket’ of securities on the basis of which all other securities can be evaluated or considered to be adequately approximated. In typical cases of interest, the number k of such risk factors may be quite large (for example, k=400, or more or less). It is assumed that over the single time interval in question, X has a k-dimensional multivariate normal distribution with zero mean vector (since the time interval is typically small) and with variance-covariance matrix Σ. We denote this distributional assumption as follows:

X˜N^{k} (0, Σ).

The k×k matrix Σ is constant (over the time interval considered) and is considered to be known. The estimation of such variance-covariance matrices Σ is a well-known and substantial process in its own right, and is described, for example, in the cited RiskMetrics document; it can involve extensive statistical methods including GARCH time series analysis and other intensive statistical and data-analytic methods.

A complex portfolio, of the kind typically held by large financial institutions, and possibly containing derivative securities, but not limited thereto, has a return (over the same single time period) given by a function g(X) where X is the vector of returns on the risk factors mentioned previously. The function g(·) is determined, using methods known to those trained in this art and science, by the various individual holdings in the portfolio, and usually is the market-value based weighted-average of the returns on the individual assets held in the portfolio. The returns on the individual assets are, in turn, each considered to be known functions of the risk factor returns X. Some of these will be simple linear functions, as for example when the portfolio has direct holdings in one or more of the k underlying risk factors (securities, indices, etc.). Others amongst these functions can be substantially more complex; for example when derivative securities are held in the portfolio, they may be complicated nonlinear functions of X based on formulae such as that of Black-Scholes or its many variants. For each individual security held in the portfolio, there will be an exact or approximate pricing function (formula) giving the value of that security in terms of the values of the underlying risk factors. The determination of such pricing functions is a mathematically substantial task in its own right.

As a specific example, and to help fix ideas, if the portfolio only contains direct holdings in the k risk factor assets (whose returns vector is given by X) and if a is the column vector (with elements summing to 1 in this case) giving the dollar proportions invested in these various assets, then we are in the so-called fully linear case and will have return given by the linear function g(X)=a′X for this portfolio. Here and elsewhere, the ‘prime’ represents the mathematical transpose operation. This case may be treated by elementary methods, the details of which are well-known to anyone schooled in the arts and methods of statistical theory and its applications.

The more general problem of particular interest here is this: given the known multivariate normal distribution for the risk factor returns X, and the known (but not necessarily linear) return function g(·) for the overall portfolio, determine the lower α-th quantile of the statistical probability distribution of g(X). This quantile (often with α=0.05 or 0.01), multiplied by the overall market value of the portfolio, is usually referred to as the Value at Risk (VaR) of the portfolio (for the given time period). Institutions and entities holding large portfolios are often required to determine such Value at Risk (VaR) quantites for the purpose of satisfying regulatory requirements, to determine the quantity of funds to hold in reserve in order to satisfy market based contingencies, and to assess the riskiness of their holdings for their own internal planning and management purposes. Some further background on this is given in the cited RiskMetrics document.

One approach to this problem is to statistically sample X from the N^{k}(0, Σ) distribution a large number of times, typically using a method involving a Cholesky decomposition of Σ, and then estimate the VaR from the α-th quantile of the empirical distribution obtained for g(X) under the repeated Monte Carlo evaluations of this function. This Monte Carlo approach, although theoretically unbiased under the stated assumptions, suffers in practice from a number of drawbacks. For example, it can be difficult to carry out the multivariate normal sampling when k is large, since the matrix Σ needs first to be Cholesky factorized (or a matrix square root must be found by some alternate means), and sampling from N^{k}(0, Σ) then requires repeated high-dimensional matrix-vector multiplications. Further, the repetitive evaluations of complicated g(·) functions are often themselves numerically cumbersome and computationally time consuming. Another drawback of the Monte Carlo method is that the resulting VaR estimate will itself be subject to sampling variability between one full Monte Carlo ‘experiment’ and the next—i.e. the final answer differs with every set of Monte Carlo trials performed, often substantially so, even for quite large numbers of Monte Carlo trials. Last, but not least, the number of Monte Carlo trials required the estimate the α-th quantile at all accurately, especially when α is small (as it typically is), can be extremely large.

Monte Carlo computations for VaR can be speeded up, to some extent, by using a simplifying approximation to the function g. Common amongst these is the so-called delta-gamma approximation. This involves firstly making Taylor series approximations for the pricing function of each of the assets in the portfolio on which g(·) is based. These component approximations are then summed over all the assets in the portfolio to obtain the Taylor's approximation for the overall portfolio. Since the components of the vector of risk factor returns X are typically small, and the coefficients in the higher order terms of the Taylor approximations are typically not large, it often suffices to keep only the linear and quadratic terms of the Taylor approximation; this often yields a sufficiently precise approximation for the overall g(·) function. For historical reasons, the linear terms of the Taylor approximation are called deltas, while the quadratic terms are called gammas; overall, this second order (i.e. quadratic) Taylor expansion approximation to g(·) is known as a delta-gamma approximation. When still higher order terms are used, they too are labeled as “greeks” Nevertheless, even when using a delta-gamma approximation in place of g, the Monte Carlo approach can still be computationally demanding in portfolios which are large and based on many underlying assets.

Current methods to compute the value at risk of a portfolio are beset with a variety of problems in application. The Monte Carlo method suffers from the fact that it is very computer intensive. In particular, many thousands of Monte Carlo trials have to be executed in order to begin to achieve acceptable levels of accuracy in typical VaR computations. For every one of those trials, it is necessary to generate another realization of the values of the underlying risk factors. Doing this many times for a large number of risk factors is time consuming, even with currently available fast computing machinery. Furthermore, it is typically necessary to evaluate the price of every asset in the portfolio for each one of these Monte Carlo generated scenarios. In large portfolios consisting of hundreds, or even thousands, of individual financial instruments, these computations are burdensome and can be very time consuming since this involves large numbers of evaluations of price functions of financial instruments—thus often requiring millions or more of such evaluations. One key advantage of our approach is speed. In our method, the quadratic approximation function to the value of the total portfolio needs to be determined one time only. The elimination of the need for Monte Carlo trials in our approach further increases the speed of our procedure by a very large factor. The second key advantage of our method is accuracy. In the Monte Carlo procedure, the accuracy of an estimated VaR quantity increases very slowly with increasing number of trails—in fact the accuracy of Monte Carlo based estimates is known to increase inversely with the square root in the number of trials.

Several competing methods for determining VaR are described in the paper “Delta-Gamma Four Ways” by J. Mina and A. Ulmer recently available from RiskMetrics Inc. One of the procedures described there is a so-called Fourier method which involves determining the characteristic function (i.e. the Fourier transform) of the probability distribution of the quadratic form in the multivariate normal random variables which approximates the value of the portfolio. This characteristic function is then inverted, typically by means of a fast Fourier transform algorithm, to obtain the distribution function for the portfolio's values, and the VaR is then determined from this distribution. Some background on how such Fourier inversion is carried out may be found in Feuerverger and McDunnough (1981). The Fourier method is technically quite difficult to implement, and furthermore is known to be inaccurate in the far tails of the distribution due to phenomena such as truncation, discretization, and aliasing which occurs with the use of this method; yet it is in the tails of the distribution where accuracy is most needed for accurate determination of VaR.

Another advantage of this invention concerns a method for high order approximation for those cases where the behavior of the pricing function is highly non-linear so that approximations to the pricing function based on a second order approximation would be insufficiently accurate.

### SUMMARY OF THE INVENTION

The invention is a method and system for determining VaR. The invention does not require Monte Carlo sampling. Alternatively, if Monte Carlo sampling is used, it requires only a reduced number of such trials. The invention is based on reducing the pricing function of the overall portfolio to a delta-gamma approximation, which in effect is a quadratic form in the risk factors; the distribution of the risk factors is, in turn, assumed to be a known multivariate normal distribution; the distribution of this quadratic form in normal variables is then determined by means of first evaluating the moment generating function (Laplace transform) of this distribution, and then applying highly accurate methods of saddlepoint approximation to this moment generating function to determine the distribution and its guantiles.

Our method immediately provides a highly accurate approximation to the VaR whose accuracy is limited only by the machine precision of the computers used, by the adequacy of the quadratic approximation to the value of the portfolio, and by the accuracy of the saddlepoint approximation itself, which is central to our method. The saddlepoint approximation is in fact known to be extremely accurate, and to become ever more so as larger numbers of securities arc involved.

Due to the speed and practicality offered by our method, it becomes feasible to carry out repeated VaR determinations in a short period of time, thereby opening up the practical possibility to carry out “what if” scenarios, whereby VaR computations are carried out for many possible adjustments that might be under consideration for the portfolio. Such what if computations may, for example, be used to consider the effects to risk of adding certain particular additional investment instruments to the portfolio, or it may be used to gauge whether adding a particular instrument will have the overall effect of stabilizing the overall riskiness of the portfolio. Such computations may also be used to quickly determine VaR quantities for a large number of sub-components or sub-aggregates of the overall portfolio, for example, to carry out a branch by branch VaR computation for the various branches or departments of a financial institution.

The invention includes a method of determining the risk in possessing a portfolio having a portfolio return, the portfolio including holdings each having a holding return, the holdings having been mapped to risk factors for which the parameters of a multivariate normal statistical distribution have been determined, the method including:

expressing each holding return as a quadratic form in the returns of the risk factors;

Aggregating the quadratic forms in the holdings to obtain a quadratic form approximation for the portfolio;

determining a cumulant generating function of the quadratic form of the portfolio return and the first and second derivatives of the cumulant generating function;

inputting the cumulant generating function and the derivatives into a saddlepoint approximation of first order or higher order from which the statistical distribution function of the portfolio return is provided, and

providing a Value at Risk quantity from a tail area of the statistical distribution function of the portfolio return.

In a variation, the invention includes a method of determining the risk in possessing a portfolio having a portfolio return, the portfolio including holdings each having a holding return, the holdings having been mapped to risk factors for which the parameters of a discrete or continuous mixture of multivariate normal distributions has been determined, the method including:

expressing each holding return as a quadratic form in the returns of the risk factors;

aggregating the quadratic forms in the holdings to obtain a quadratic form approximation for the portfolio;

determining a cumulant generating function of the quadratic form in the portfolio return and the first and second derivatives of the cumulant generating function;

inputting the cumulant generating function and the derivatives into a saddlepoint approximation of first order or higher order from which the statistical distribution function of the portfolio return is provided, and

providing a Value at Risk quantity from a tail area of the statistical distribution function of the portfolio return.

Another aspect of the invention relates to a system for determining the risk in possessing a portfolio having a portfolio return, the portfolio including holdings each having a holding return the holdings having been mapped to risk factors (i) for which the multivariate normal distribution has been determined or (ii) for which the parameters of a discrete or continuous mixture of multivariate normal distributions has been determined, the method including:

a) means for expressing each holding return as a quadratic form in the returns of the risk factors;

b) means for Aggregating the quadratic forms in the holdings to obtain a quadratic form approximation for the portfolio;

c) means for determining a cumulant generating function of the quadratic form in the portfolio return and the first and second derivatives of the cumulant generating function; and

d) means for inputting the cumulant generating function and the derivatives into a saddlepoint approximation of first order or higher order from which the statistical distribution function of the portfolio return is provided,

wherein a Value at Risk quantity can be provided from a tail area of the statistical distribution function of the portfolio return.

A further aspect of the invention involves determining the risk in possessing a portfolio having a portfolio return, the portfolio including holdings each having a holding return, the holdings having been mapped to risk factors for which the parameters of a multivariate normal statistical distribution have been determined, the method including:

expressing each holding return as an expanded multivariate polynomial of the third or higher order in the returns of the risk factors;

aggregating the multivariate polynomials to obtain an expanded multivariate polynomial representing the return of the overall portfolio;

determining a pre-determined number of the first few cumulants of the expanded polynomial;

determining an approximate cumulant generating function of the expanded polynomial in the portfolio return using the first cumulants;

determine the first and second derivatives of the cumulant generating function;

inputting the cumulant generating function and first and second derivatives into a saddlepoint approximation of first order or higher order from which the statistical distribution function of the portfolio return is provided, and

providing a Value at Risk quantity from a tail area of the statistical distribution function of the portfolio return.

The mixture of multivariate normal distributions may include a convolution and/or a kernel density estimator.

The holdings preferably comprise financial instruments. Holdings may also include, for example, real estate. The quadratic form preferably includes a function which is a sum of a first part and a second part, the first part including a linear term in the risk factor returns; the second part including a quadratic term in the risk factor returns. The cumulant generating function is preferably obtained from a transform including a characteristic function or a moment generating function of the statistical distribution of the quadratic form. The method preferably includes determining a cumulant generating function of the quadratic form in the portfolio return and first, second and/or higher derivatives. The quadratic form is preferably determined from a pricing formula for derivative securities. The formula preferably comprises a Black and Scholes formula, a Cox-Ingersol-Ross formula, a Heath-Morton-Jarrow formula, a binomial pricing formula a Hull-White formula, and other formulae. The cumulant generating function is preferably determined from a Laplace transform, a Fourier transform, a Mellin transform, or a probability generating function. The saddlepoint approximation preferably includes a Lugannani and Rice saddlepoint approximation, a Barndorff-Nielsen saddlepoint approximation, a Rice saddlepoint approximation, a Daniels saddlepoint approximation, or a higher order saddlepoint approximation. The quadratic form is preferably determined analytically or numerically with the gradient and/or Hessian of a function or of a computing program which determines the return of the portfolio return. The portfolio return is preferably expressed as a sum of two functions, the first term of which is a linear term, a quadratic term or a sum thereof, and the second term being a residual term. Monte Carlo trials may also be used with the methods and systems of the invention to determine the Value at Risk. The methods and system may comprise a computer. The invention includes a value at risk provided in accordance with any of the methods of systems of the invention.

The invention is faster, cheaper and more accurate than known methods and systems for calculating Value at Risk.

### DETAILED DESCRIPTION OF THE INVENTION

The steps involved in making and using this invention include the following. Beginning with a portfolio of financial instruments for which we wish to determine a Value at Risk, we firstly list or itemize the holdings in the portfolio. Itemization may be done for small portofolios, or, for example, for large financial institutions. Once such an itemization has been produced, it usually is relatively an easier task to update it from one time period to the next just by removing from it the instruments that have been sold, and adding to it the instruments that have been acquired, in the interim.

Secondly, determine the collection of risk factors on the basis of which the values all the instruments in the portfolio will be priced. These risk factors will usually consist of various international equity indices, foreign exchange rates, commodity prices, interest rates for various maturities, and many other similar quantities which fluctuate randomly and/or statistically over every interval of time. The production of a suitable such collection of risk factors is a substantial task in its own right, not least because of the fact that such a collection may require or include upwards of 400 such variables. The methods for doing so are discussed in the cited RiskMetrics document and known in the art. In general, one preferably uses risk factors for which adequate historical data may be obtained for the purpose of assessing their statistical behaviour, and yet include enough risk factors so that all or most financial instruments can be priced in terms of the values of these risk factors. Normally, such a collection of risk factors would be either obtained or purchased from commercial entities such as J. P. Morgan and/or RiskMetrics Corporation, Reuters, BARRA, Algorithmics, Infinity, or other companies which produce and sell such financial and statistical information.

Thirdly, one obtains or determines an estimate for the statistical distribution of the returns on the risk factors which is considered to be appropriate for the period of time in question—a day, a week, a month, or other such time interval over which the VaR quantity needs to be determined. (The VaR depends upon the time frame. Specifically, it depends upon the length of the time interval in question, and it also depends upon current market volatility conditions.) A common assumption is that returns on the risk factors follow a multivariate normal distribution. A multivariate normal distribution is entirely specified once we know its vector of means and its variance-covariance matrix. Over short time periods, of the type ordinarily involved in VaR computations, it is reasonable and usual to assume that the mean returns vector is zero. (However the applicability of our invention is not restricted to this case.) The variance-covariance matrix of the return vector is a large object that is hard to estimate. For example if there are 400 risk factors, the variance-covariance matrix will be of dimension 400×400. Substantial statistical methodology, effort, and skill is required in order to determine such matrices. Detailed discussion of how to determine such matrices is provided in the RiskMetrics technical document and in the references provided therein, and also in related references that appear throughout the statistical and financial journals and literature. Ordinarily, a company carrying out a VaR analysis of its portfolio may not undertake to produce this matrix by itself, but may instead acquire it or purchase it from a company or companies that specializes in producing such statistical-financial information. In recent years, J. P. Morgan and RiskMetrics Corporation have produced and provided such matrices, even at no charge, through data bases made available through the Internet. They have provided two such matrices, often called volatility matrices, and updated on almost a daily basis, one such matrix being relevant to the one day time interval of holding (this matrix would be the relevant one for assessing risk of holding a portfolio overnight) and the other such matrix being relevant for a one month time interval of holding. Additional companies and sources known in the art produce and provide such volatility and distributional data.

A fourth step is to determine the pricing (i.e. the market value) of each one of the individual financial instruments in the portfolio, as a function of the values of the risk factors. In part, this step involves ‘mapping’ the holdings of the portfolio to appropriate risk factor ‘vertices’. As a specific example, if the portfolio includes holdings in a basket full of stocks, it ordinarily is not feasible to include all such stocks in the set of risk factors, and to separately estimate the variances and covariances of their returns. In fact, normally, the set of risk factors will include only certain major stock indices such as the Dow Jones Industrial Average, the Standard and Poors 500 average and various of its sub-aggregates, various foreign equity indices, and so on. It is therefore necessary to decide what percentage of each individual stock holding should be “mapped” onto each of the stock indices in the risk factor set. A governing statistical principle for doing this is to carry out the mapping in such a way that the mapped portfolio will fluctuate in a like manner to the actual portfolio. Methodologies for doing so are discussed in the RiskMetrics document. As another example, a portfolio may have extensive bond holdings involving payouts at many different future dates. Again, it is not feasible for the risk factor set to include prices for zero coupon bonds of every possible duration. Normally only durations such as 1, 2, 3, and 6 months would be included, as well as 1, 2, 5, 10, 20 and 30 years. All bond-like instruments held in the portfolio must therefore be mapped or appropriately allocated amongst the available risk factors designed for that purpose. Methods for doing so are provided in the RiskMetrics document. Considerable further complexities arise in regard to holdings that are so-called derivative security instruments such as put, call and other types of options. For such holdings, it is necessary to have a mathematically and/or empirically derived pricing formula that gives the price (market value) of the instrument as a function of the risk factors. Such pricing formulae are known in the art. See for example, Hull, 1989, 1998, for a summary of this area. For example, the well-known Black-Scholes formulae give the pricing of certain particular put and call options under certain particular assumptions. Likewise other formulae are known or may be derived for other types of financial instruments. The availability of such pricing formulae is a prior art. Many companies and consultants sell such financial-mathematical information. An important feature of such pricing formulae is that they need not be (indeed they are generally not) linear functions in the risk factors.

The fifth step involves combining the pricing functions of the individual portfolio holdings to obtain one overall formula g(X) for the pricing of the overall portfolio as a function of all the risk factors. (Here the dimension of X is the same as the number of risk factors, and the individual entries in the X vector give either the returns, or the prices, for the risk factors.) To apply the method of our invention, one approach is to use a quadratic approximation to this overall pricing function. (A quadratic function is one that has only sums of linear terms in it as well as sums of products of pairs of linear terms.) In order to obtain this overall quadratic multivariate function, we may obtain the quadratic approximation to each individual pricing function using the methods of ordinary calculus and Taylor approximation. Such approximations are referred to in the financial industry as delta-gamma approximations. These individual delta-gamma approximations are then summed over all holdings in the portfolio to obtain the delta-gamma (quadratic) approximation function for the overall portfolio. This overall delta-gamma approximation is then written in the matrix form that is shown at equation (2). An alternative approach for obtaining the delta-gamma approximation to the overall portfolio may be used if there is available a formula, or a computer routine, or the like, for valuation of the portfolio as a function in the prices of the risk factors. In this case one may determine the gradient and the Hessian of this function (as well as higher derivatives), either analytically or computationally, and thereby obtain the coefficients for the overall quadratic approximation.

Another aspect of this invention involves a higher order multivariate polynomial approximation to g(X), the pricing function, to handle those cases of greater nonlinearity. The approach consists of determining the first (typically at least four) cumulants of the expanded polynomial expression for g(X). These cumulants are preferably used to approximate the cumulant generating function of the portfolio returns. The saddlepoint approximation discussed earlier is then applied with this cumulant generating function and its first two derivatives. A description of the mathematical basis for this method and the previous method using a quadratic approximation follows later.

Given the distribution of the set of risk factors, i.e. the variance-covariance matrix of its normal distribution, and given the delta-gamma or higher order approximation to the pricing of the portfolio, we may now proceed mathematically as explicitly described elsewhere in this document to obtain the desired VaR quantities.

Numerous variations on the steps detailed here will be apparent to persons skilled in these arts given the method steps.

The invention provides a method for determining the Value at Risk, over a given time interval, for a portfolio of financial instruments that have been mapped to a set of risk factors for which a multivariate normal distribution of returns has been determined.

The invention includes a method of determining the risk in possessing a portfolio having a portfolio return, the portfolio including holdings each having a holding return, the holdings having been mapped to risk factors for which the parameters of a multivariate normal statistical distribution have been determined, the method including:

expressing each holding return as a quadratic form in the returns of the risk factors;

aggregating the quadratic forms in the holdings to obtain a quadratic form approximation for the portfolio;

determining a cumulant generating function of the quadratic form in the portfolio return and the first and second derivatives of the cumulant generating function;

inputting the cumulant generating function and the derivatives into a saddlepoint approximation of first order or higher order from which the statistical distribution function of the portfolio return is provided, and

providing a Value at Risk quantity from a tail area of the statistical distribution function of the portfolio return.

In a variation, the invention includes a method of determining the risk in possessing a portfolio having a portfolio return, the portfolio including holdings each having a holding return, the holdings having been mapped to risk factors for which the parameters of a discrete or continuous mixture of multivariate normal distributions has been determined, the method including:

expressing each holding return as a quadratic form in the returns of the risk factors;

aggregating the quadratic forms in the holdings to obtain a quadratic form approximation for the portfolio;

determining a cumulant generating function of the quadratic form in the portfolio return and the first and second derivatives of the cumulant generating function;

inputting the cumulant generating function and the derivatives into a saddlepoint approximation of first order or higher order from which the statistical distribution function of the portfolio return is provided, and

providing a Value at Risk quantity from a tail area of the statistical distribution function of the portfolio return.

The method involves summing the quadratic approximating functions in the risk factors (to approximate the prices) of each of the financial instruments held in the portfolio. Many such quadratic functions are added together and the sum is a (multi-dimensional) quadratic form which provides an accurate approximation to the portfolio's overall value and therefore allows an accurate determination of the VaR.

In a further variation, this invention involves determining the risk in possessing a portfolio having a portfolio return, the portfolio including holdings each having a holding return, the holdings having been mapped to risk factors for which the parameters of a multivariate normal statistical distribution have been determined, the method including:

expressing each holding return as an expanded polynomial of the third or higher order in the returns of the risk factors;

aggregating the multivariate polynomials for the holdings to obtain a multivariate form approximation for the portfolio return;

determining a predetermined number of the first cumulants of the expanded polynomial;

determining a cumulant generating function of the expanded polynomial in the portfolio return using the first cumulants;

determine the first and second derivatives of the cumulant generating function;

inputting the cumulant generating function and first and second derivatives into a saddlepoint approximation of first order or higher order from which the statistical distribution function of the portfolio return is provided, and

providing a Value at Risk quantity from a tail area of the statistical distribution function of the portfolio return.

The method preferably involves prior estimates of the statistical properties of the risk factors by means of a multivariate normal distribution. A mixture, in some proportions, of multivariate normal distributions having different parameters can also be accommodated using the methods of the invention.

The methods outlined herein possess a number of important advantages relative to other methods currently in use. By eliminating or significantly reducing reliance upon Monte Carlo evaluations, the results of Value at Risk computations can be completed much more quickly. This opens up practical possibilities for carrying out VaR computations for a large number of variants of any particular portfolio—thus permitting so-called ‘what-if’ analyses to be completed within a reasonable amount of time. A second advantage of the method is accuracy of the results obtained. When the underling quadratic approximation is exact, and the normal distribution for the risk factors is exact, then the results obtained will be extremely accurate. Very considerable accuracy is maintained even under substantial deviations from these ideal assumptions. A third advantage of our algorithm is that it may be computer coded more quickly than competing algorithms, since the basic final formulas that need to be coded are simpler to deal with than those of competing algorithms.

System for Determining Value at Risk

Implementation of the invention is carried out in conjunction with digital computing equipment. The method is implemented as a stand-alone method, or as part of a comprehensive computational software package or other system for dealing with computations that arise in the financial industries and in Value at Risk applications. As a stand-alone method, it is implemented in almost any computing language, such as C++ or Fortran or machine language, with or without conjunction with other mathematical, statistical or other computer software packages. Implementation of the method preferably (but not necessarily) includes access to standard computing routines for matrix algebra to carry out such standard matrix manipulation tasks as singular value decomposition, determination of eigenvalues and eigenvectors, Cholesky factorization, and the like; alternately the required matrix algorithms are coded as part of our method. The method is then ‘called’ (for example as a subroutine) in conjunction with data, for example, providing the linear and quadratic coefficients of the quadratic form that describes the risk-factor mapped portfolio and the variance-covariance matrix of the normal distribution which describes the variation of the underlying risk factors onto which the portfolio is mapped. This method is incorporated into a comprehensive package or system of computer routines and procedures intended for risk analysis and related financial applications.

A preferred embodiment of this invention relates to a computer system with storage capability storing a set of computer instructions, which system, when operating under the control of the computer instructions, implements the steps of the method outlined above.

Description of Mathematical Basis for the Invention.

Let X=(X₁, . . . , Xₖ)′ be the random vector of returns, over one time period, for our underlying risk factors, and let g(X) represent the return for the portfolio of interest over that period of time. It is assumed that X follows the multivariate normal distribution described previously as

X˜Nₖ(0, Σ) (1)

A ‘delta-gamma’ Taylor approximation to g(X) may then be written in the form

Y=a₁′X+X′B₁X, (2)

where a, is a k×1 column vector giving the linear coefficients, B, is a κ×k matrix giving the quadratic coefficients, and where prime represents matrix transposition. (Some authors will include a factor of ½ at the quadratic component, but this does not change the nature of the computations in any essential way.) Both a, and B, as well as the variance-covariance matrix Σ of the normal distribution, are considered to be real-valued, constant, and known. The vector a₁ may consist of nonnegative entries which sum to one (as would be the case for a simple “linear” portfolio) but this is not a requirement in the arguments below. The matrix B₁ may, of course, be taken to be symmetric, for otherwise we may just replace it with (½)(B₁+B₁′) in the quadratic form (2). We also remark, in passing here, that X is not restricted, in our method, to have a zero mean vector. For if μ is the intended mean of X, then we can still take X to have mean zero, but write a′₁(X+μ)+(X+μ)′B₁(X+μ) in place of (2), and this can immediately be reduced to the same form as (2) plus a constant.

For purposes of Monte Carlo simulation, X may be generated via X=HZ₍₁₎ using any H which satisfies

Σ=HH′, (3)

with Z₍₁₎ being a k×1 column vector consisting of independent standard normal components. For simulation applications, H is typically chosen to be lower triangular (this is the so-called Cholesky factorization) in order to minimize the number of computations in X=HZ₍₁₎, but this is not a requirement in the work below. It follows that (2) can be written as

Y=a₁′(HZ₍₁₎)+(HZ₍₁₎)′B₁(HZ₍₁₎),

or as just

Y=a₂′Z₍₁₎+Z₍₁₎′B₂Z₍₁₎, (4)

where

a₂=H′a₁ and B₂=H′B₁H. (5)

Note that here also, B₂ can be assumed to be a symmetric matrix.

The portfolio is permitted to contain both long as well as short positions; for this and for other reasons as well, the matrix B₂ need not be nonnegative definite; indeed it usually will not be. (The same assertion also holds for B₁, of course.) But because it is symmetric, it will, however, have real eigenvalues −∞<λ₁≦λ₂≦ . . . ≦λₖ<∞, and corresponding real, orthonormal, (column) right-eigenvectors P₁, P₂, . . . , Pₖ which may be bound together column-wise (we shall use the notation ‘cbind’ to denote this) to form an orthogonal matrix denoted by

P=cbind (P₁, P₂, . . . Pₖ).

In this notation, the singular value decomposition for B₂ may be written as

$${B}_{2} = P Λ {P}^{′} = {\sum }_{j = 1}^{k} {λ}_{j} {P}_{j} {P}_{j}^{′} ,$$

where Λ=diag (λ₁, . . . , λₖ) is the diagonal matrix formed from the eigenvalues.

We next rewrite (4) as

Y=a₂′PP′Z₍₁₎+Z₍₁₎′PΛP′Z₍₁₎

or as just

Y=a′Z+Z′ΛZ (6)

where

a=P′a₂=P′H′a₁, and Z=P′Z₍₁₎. (7)

Note that Z=(Z₁, . . . , Zₖ))′ also consists of independent standard normal variables. Finally, we write (6) in the equality in distribution form

$$Y {=}^{d} {\sum }_{j = 1}^{k} ( {α}_{j} {Z}_{j} + {λ}_{j} {Z}_{j}^{2} ) . \qquad ( 8 )$$

Here aⱼ are the components of the vector P′H′a₁ and λⱼ are the eigenvalues of H′B₁H. Note that these λⱼ also are the eigenvalues of B₁Σ and of ΣB₁, since in general the eigenvalues of AB and BA are the same. Note further, that in the computation of P′H′a₁, the matrix P′ is an orthogonal (hence length-preserving) transformation on the vector H′a₁. Consequently, we will require accurately only those columns Pⱼ of P which correspond to eigenvalues that are appreciably different from zero. To understand why, suppose that we have a subset of near-zero eigenvalues whose sum of squares is much less than the total Σⱼ₌₁^{k}λⱼ². Then, over that subset, the contribution of the corresponding λⱼZⱼ² terms in (8) will be negligible. The corresponding aⱼZⱼ terms in (8) can then be collected together into a single term, say aₒZₒ, where aₒ² equals the sum of squares of the aⱼ values so removed. In fact, the value of aₒ can be obtained using the mentioned length-preservation property, and aₒ² will equal the squared length of H′a₁, less the sum of squares of the remaining aⱼ which are included in the sum.

The next step is to establish some transform characteristics of the distribution corresponding to (8). Thus observe next that the moment generating function of (8) is given by

$${M}_{Y} ( t ) = {Ee}^{tY} = {\{ {\prod }_{j = 1}^{k} ( 1 - 2 {λ}_{j} t ) \}}^{- 1 / 2} \times exp \{ \frac{1}{2} {\sum }_{j = 1}^{k} \frac{{a}_{j}^{2} {t}^{2}}{1 - 2 {λ}_{j} t} \} , \qquad ( 9 )$$

or in matrix notation by, say

$$\begin{matrix}{M}_{Y} ( t ) = {\{ Det ( I - 2 t \sum {B}_{1} ) \}}^{- 1 / 2} \times \\ exp \{ \frac{{t}^{2}}{2} {{a}_{1}^{′} ( {\sum }^{- 1} - 2 {tB}_{1} )}^{- 1} {a}_{1} \} .\end{matrix} \qquad ( 10 )$$

The computations for this result are given, for example, in Feuerverger and Wong (2000). Note that if the maximum eigenvalue λₖ is >0 we will have the requirement that t<(2λₖ)⁻¹; and if the minimum eigenvalue λ₁ is <0 we have the requirement that t>(2λ₁)⁻¹ in order that the moment generating function should be finite. Altogether, M_{Y}(t) will always be finite in an interval around the origin; in fact, the region of finiteness will be either a finite or semi-infinite interval, and will include the origin as an interior point. The associated cumulant generating function is given by

$$K ( t ) = log {M}_{Y} ( t ) = - \frac{1}{2} {\sum }_{j = 1}^{k} log ( 1 - 2 {λ}_{j} t ) + \frac{1}{2} {\sum }_{j = 1}^{k} \frac{{α}_{j}^{2} {t}^{2}}{1 - 2 {λ}_{j} t} \qquad ( 11 )$$

or, in matrix notation, by

$$K ( t ) = - \frac{1}{2} log Det ( I - 2 t \sum {B}_{1} ) + \frac{1}{2} {t}^{2} {{a}_{1}^{′} ( {\sum }^{- 1} - 2 {tB}_{1} )}^{- 1} {a}_{1} \qquad ( 12 )$$

while its first two derivatives (which typically will be required for our procedure) are readily determined to be

$$\begin{matrix}{K}^{′} ( t ) = {\sum }_{j = 1}^{k} \frac{{λ}_{j}}{1 - 2 {λ}_{j} t} + {\sum }_{j = 1}^{k} \frac{{a}_{j}^{2} ( t - {λ}_{j} {t}^{2} )}{{( 1 - 2 {λ}_{j} t )}^{2}} , \\ and & ( 13 ) \\ {K}^{″} ( t ) = {\sum }_{j = 1}^{k} \frac{2 {λ}_{j}^{2}}{{( 1 - 2 {λ}_{j} t )}^{2}} + {\sum }_{j = 1}^{k} \frac{{a}_{j}^{2}}{{( 1 - 2 {λ}_{j} t )}^{3}} . & ( 14 )\end{matrix}$$

Higher derivatives are also readily determined. Note that by evaluating the derivatives at t=0, we may also obtain the actual cumulants associated with this cumulant generating function. These cumulants are associated with the coefficients in the Taylor series (i.e. power series) expansion of the cumulant generating function.

These exact formulas for the cumulant generating function and its derivatives are next plugged into a saddlepoint approximation for determining the tail areas of the distribution of the quadratic form in the multivariate normal variables. This procedure will be described in the next section.

We mention here, in passing, that the distribution corresponding to (9) can be determined using numerical Fourier inversion of the characteristic function corresponding to it, as is typified, for example, in Feuerverger and McDunnough (1981). This method, however, is numerically cumbersome and is more difficult to implement, and in particular suffers from numerical inaccuracy in the tails which is the region of greatest interest in VaR work. In fact the methods proposed here permit one to correct for such inaccuracies in the distribution tails. In any case, our invention provides an alternative approach which does not suffer from these difficulties.

The Saddlepoint Approximation Procedure

To set the stage, consider first the classical statistical problem involving random variables X₁, X₂, . . . , Xₙ, that are identically and independently distributed, and drawn from a distribution whose cumulant generating function k(t) is finite throughout an interval for t which includes 0 in its interior. Then the saddlepoint approximation in the form due to Lugannani and Rice (1980) for the distribution function of the sample mean \overline{X}=(1/n)Σ₁ⁿXᵢ is given by

$$P [ \overline{X} > \overline{x} ] = 1 - {F}_{\overline{X}} ( \overline{x} ) \sim 1 - Φ ( r ) + ϕ ( r ) ( \frac{1}{u} - \frac{1}{r} ) , \qquad ( 15 )$$

where Φ and φ are the cumulative distribution and density functions of a standard normal variable. There are numerous such alternative approximations that may be located in the literature and will therefore be known to those trained in the field of statistical theory and applications. One such alternative approximation, due to Barndorff-Nielsen (1986, 1991), is given by

$$1 - {F}_{\overline{X}} ( \overline{x} ) \sim 1 - Φ ( r - \frac{1}{r} log \frac{r}{u} ) . \qquad ( 16 )$$

In both of the cases above,

τ=±\sqrt{2n}}\hat{φ}\overline{x}−k(\hat{φ})}^{1/2} and u=\hat{φ}{nk″(\hat{φ})}^{1/2} (17)

while \hat{φ}, the so-called saddlepoint, is defined via the equation

k′(\hat{φ})=\overline{x}, (18)

and the sign of τ is chosen to be the same as that of \hat{φ}. The primes appearing in the formulas here represent the mathematical operation of function differentiation. Other related tail-area approximations are given in Daniels (1987). Higher order approximations are also available and may also be used for further accuracy. For additional background see also Barndorff-Nielsen and Cox (1979, 1989), Davison and Hinkley (1988), and Reid (1996), or one of several recent books and research monographs in the field of mathematical, theoretical and applied statistics dealing with saddlepoint approximations and related material. Such material may also be located via the MathSciNet web-site maintained by the American Mathematical Association, the Current Index in Statistics, maintained by the American Statistical Association, and similar sources.

The saddlepoint approximation to the tail area of \overline{X} is known to be extremely accurate, even for values of n as low as 3, 2, or even 1. Further, it is exact when the underlying distribution is either normal, gamma or inverse normal. See, for example, Daniels (1980), Hampel (1974), Feuerverger (1989), and Ronchetti and Field (1990). This high degree of accuracy derives from the third order error structure of the saddlepoint approximation, and specifically from equalities such as P[\overline{X}>\overline{x}]=1−Φ(r)+φ(r)(u⁻¹−r⁻¹+O(n^{-3/2})); see for example Daniels (1987), Lugananni & Rice (1980), and Barndorff-Nielsen & Cox (1979, 1989) and many related research publications.

The quantity (8) arising in our VaR application does not involve a sample mean or sample total; nevertheless, it does involve a significant amount of convolution so that the saddlepoint method is again applicable to it with a very high degree of accuracy. This accuracy is demonstrated in the article by Feuerverger and Wong (2000), submitted for publication. Note, however, that because the convolution (8) does not consist of identically distributed quantities, it is necessary to modify the approximation formulae so that K(t) given in (11) now plays the role of nk(t). In this more directly relevant notation, the saddlepoint formulae for the tail areas of the statistic (8) continue to be given by (15) and (16) except that (17) is now replaced by

r=±\sqrt{2}{\hat{φ}\overline{x}−K(\hat{φ})}^{1/2} and u=\hat{φ}{K″(\hat{φ})}^{1/2}, (19)

while (18) becomes

K′(\hat{φ})=\overline{x}. (20)

Here K, K′ and K″ are as given in (11), (13) and (14). (Note that the expressions (19) and (20) involves primarily a change in notation, with K(t) replacing nk(t). Alternately, we may think of these expressions as giving the saddlepoint approximation for the case of a sample of size n=1, but from the convolved distribution defined by K(t).)

If it is desired to compute (15) for \overline{x} in the vicinity of the distribution mean (where \hat{φ} will be near to zero) then r and u will both be near zero, causing numerical problems when evaluating

$$d = d ( u , r ) = \frac{1}{u} - \frac{1}{r} .$$

However, following Andrews et al (2000), and references therein, near \hat{φ}=0 we may use the approximation

$$d \sim - \frac{{α}_{3}}{6 \sqrt{n}} + \frac{{α}_{4} - {α}_{3}^{2}}{24 n} r \qquad ( 21 )$$

where α₃ and α₄ are standardized cumulants. (The j-th standardized cumulant αⱼ is defined as kⱼ/σ^{j} where kⱼ is the j-th cumulant, and σ² is the second cumulant, i.e., the variance.) Alternately we may use the linear approximation d=â+\hat{b}r, with â and \hat{b} fitted (near the singularity) by simple linear regression. In the context of our K(t) function, we use n=1 in (21) with α₃ and α₄ now being standardized cumulants of K(t). Note that, at the singularity point, (21) gives d=−α₃/6\sqrt{n,} leading to the value ½−α₃/\sqrt{72πn} for the right hand side of (15).

The saddlepoint approximation can be used to obtain the entire distribution of the portfolio loss. Alternately, it can be used to obtain a VaR quantity at a given particular probability level. In the latter case an iterative procedure such as the Newton Raphson method would be used in conjunction with the saddlepoint approximation in order to minimize the total number of computations required. The technical description of our method is now complete. Persons trained in the art and science of statistics will be able to devise many variants of these methods.

Variant of the Invention for the Case when the Portfolio Contains Assets Whose Prices are not Quadratically Approximated in the Risk Factors.

One variant upon our invention is applicable to the case where the portfolio consists of a number of assets for which the quadratic (i.e. delta-gamma) approximation to the pricing function is not used for determining VaR, while the remaining bulk of assets in the portfolio is such that the quadratic approximation is used for that purpose. In this instance, the overall portfolio may be considered to be divided up into two separate sub-portfolios; in one of these subportfolios we apply the methods involving quadratic approximation that have been described in detail herein; in the other sub-portfolio we apply the standard methods of Monte Carlo (or of any other method available) for determination of VaR, and more particularly for determination of the distribution of returns in that sub-portfolio. These procedures will result in two computed distributions for the returns—one for each of the two sub-portfolios. These two distributions, together with assessments of the correlation and statistical dependencies between the sub-portfolios can be combined in a variety of ways (including use of copulas, and/or transformation to marginal normality) to obtain estimates of the distribution, and hence of the VaR, of the overall combined portfolio; various methods for combining such computations are readily devised by persons skilled in the arts and methods of statistical theory and its applications. (A default option would be to sum the VaR quantities obtained for the sub-portfolios; this allows us to obtain a conservative estimate (i.e. an upper bound) for the VaR of the overall portfolio, the Bonferroni inequalities being of relevance here.)

One particular procedure to handle this situation may be described as follows: The portfolio return function g(X) is split up into two parts.

g(X)=g₁(X)+g₂(X)

where g₁(X) is a quadratic function. Ideally, g₁(X) contains all the contributions from instruments in the portfolio whose pricing functions are considered to be adequately approximated by a quadratic. Furthermore, g₁(X) can also contain quadratic approximations to each of the remaining instruments in the portfolio whose pricing functions are not considered to be adequately approximated by a quadratic. Put alternatively, g₁(X) might be our best (or at least a good) approximation to the overall portfolio by a quadratic pricing function, while g₂(X) would represent the difference between g(X) and g₁(X), i.e. the error made by the quadratic pricing. The function g₂(X) will typically only be a small part of the overall g(X) function. We next observe that the desired values of the cumulative distribution function of g(X) may be written in the form

EI[g(X)≦c]=EI[g₁(X)≦c]−E{I[g(X)≦c]−I[g₁(X)≦c]}

where I is the 0-1 indicator function, and E represents the expectation operator. Observe that the first term on the right here can be readily computed by the methods which we-have given. The second term on the right involves the expectation of a quantity which will usually be 0, and will only occasionally take on the values of +1 or −1. Thus a Monte Carlo evaluation of this second expectation on the right side can ordinarily be carried out using a much reduced number of Monte Carlo trials. Such augmenting Monte Carlo trials would be used to determine the cumulative distribution function of g(X) for all values of c simultaneously, and statistical smoothing would be applied across the values of c to further improve accuracy.

As a further procedure for handling higher order nonlinearity effects, ewe remark that higher Taylor series based portfolio approximations (also called truncated Volterra-type expansions, or multivariate polynomial expansions) such as

g(X)=ΣaᵢXᵢ+ΣΣb_{i,j}XᵢXⱼ+ΣΣΣc_{i,j,k}XᵢXⱼXₖ++ΣΣΣΣd_{i,j,k,l}XᵢXⱼXₖXₗ+ (22)

can be handled by determining the first few cumulants of such expansions using: (1) linearity in the arguments of multivariate cumulant functions; (2) the Leonov-Shiryaev expansions for multivariate cumulants of products of random variables; and (3) the fact that multivariate cumulants of multivariate normal distributions are zero for cumulants beyond the covariance. See, for example, Section 2.3 of Brillinger (1975) for details of how to carry out computations of this type. With four (or more) cumulants thus available, we may then substitute the resulting Taylor expansion for the cumulant generating function into the saddlepoint approximation. The asymptotic accuracy of saddlepoint approximations can be shown to carry over whenever at least four cumulants are used; see, for example, Fraser and Reid (1993). One possible procedure here is to first obtain K(t) using a delta-gamma approximation to the portfolio, and then add to it a polynomial that corrects the first four (or more) cumulants, these first few cumulants having been accurately determined, for example, by means of the Leonov-Shiryaev based method indicated above. It is also worth remarking that the cumulants of (22) can also be computed for an empirical distribution of the X's (as would be obtained from historical data, for example); further, since nonparametric kernel density estimates are just convolutions of a kernel function with an empirical distribution, computation of the cumulants of (22) under such densities can be feasible as well. (In this last respect, the use of centered Gaussian kernels is likely to be preferred here since these possesses only a single nonzero cumulant.) The accuracy of the saddlepoint approximation methods as described herein may be expected to carry over to the case of portfolios having higher than second order nonlinearities, as long as severe amounts of such higher nonlinearities are not excessively concentrated in only a very small number of holdings that comprise a very disproportionately large weighting of the overall portfolio.

Other methods of this types described above will be apparent to those familiar with such statistical theory and methods.

Variant of the Invention for the Case when the Distribution of Risk Factors is Other than Multivariate Normal

A further variant upon the methods described herein involves the case where a distributional family other than the multivariate normals is used to describe the statistical distribution of the risk factor returns upon which the Value at Risk analysis is based. In this instance it is possible, for example, to use a statistical mixture of normal distributions. The particular normal mixture used will depend upon the particular returns distribution that it is desired to mimic, and would be determined using methods that can readily be devised by and/or that are generally known to persons knowledgable and expert in the arts and science of statistics. As one particular example, one might use a mixture of two multivariate normal distributions, the first of which occurs 95% of the time, say, and the second of which occurs the remaining 5% of the time, say. (The choice of only two components, and the percentages of 5% and 95% are being used here only for illustration, and can be varied according to underlying details of the application at hand.) The variance-covariance matrix of the second multivariate normal distribution can in some instances be taken to be a constant factor (such as 10 times, for example) of the first variance-covariance matrix, or can be otherwise quite different from the first in accordance with underlying details of the empirical or other applicable distribution of the risk factor returns. (The description herein is not intended to limit the mean vectors of the component multivariate normals to being either identical or zero.) The VaR computations described elsewhere herein can then be carried out separately for each of these two component multivariate normal distributions, resulting in two estimated distributions for returns on the portfolio. These two distributions would then be averaged in the same proportions as in the original mixture, and the VaR quantity would then be determined in the usual way from the tail areas of this averaged distribution. The underlying principle here is that the distribution of portfolio returns under a mixture distribution for the risk factors is, in general, just the corresponding mixture of the portfolio returns under the components of the mixture. Various alternative implementations of this procedure will readily be devised by persons who are knowledgable in the field. Note, for example, that a multivariate t-distribution having ν degrees of freedom may be given as a scale-mixture of multivariate normal variates, with the mixture distribution (on the scaling) being a simple function of a chi-squared distribution having the same degrees of freedom; such a distribution can then be approximated as a finite mixture of multivariate normal variables. In accordance with a Theorem by Norbert Wiener regarding the closure of translates of a function whose Fourier transform is everywhere nonzero, every multivariate distribution can be approximated by a linear combination of multivariate normal distributions in many ways.

Other methods of this type are readily devised by persons knowledgeable in this field. Thus, for example, we desire the distribution of g(X) when X has a certain multivariate density, let us call it ƒ(x); and suppose that we cannot analytically compute an approximation to this distribution except in the case that X is multivariate normal. Then we may instead proceed as follows: Obtain a multivariate normal density that closely fits to the density ƒ(x)—for example, by selecting a multivariate normal distribution which has approximately the same mean vector and variance-covariance matrix as ƒ. The distribution of g(X) under this multivariate normal distribution for X is then determined by the methods we have presented. In order to correct for the fact that the density function of X is really supposed to be ƒ, we make use of an identity such as the following:

E_{ƒ}I[g(X)≦c]=E_{N}I[g(X)≦c]+E{I[g(X_{f})≦c]−I[g(X_{N})≦c]}.

Here E_{ƒ} and EN represent expectation under the distributions ƒ and the approximating multivariate normal distribution, respectively, while X_{ƒ} and X_{N} represent random vectors which have the said ƒ and the multivariate normal distributions, respectively, but which are Monte Carlo generated in such as way as to be equal, X_{ƒ}=X_{N}, as often as possible, so that the second term on the right of the last equation will then be zero as often as possible, and hence can be efficiently estimated by Monte Carlo methods. (Such sampling of X_{ƒ} and X_{N} can be done by sampling uniformly at random from within the unit volume beneath the normal density curve; if the sampled point also lies beneath the ƒ curve, then the x-coordinate of the selected point is used as the common value of X_{ƒ} and X_{N}; if the sampled point lies above the ƒ curve, its x-coordinate is accepted as the value for X_{N}, and sampling is then carried out under the ƒ curve until a point is found lying above the normal curve, its x-coordinate then being used as the value for X_{ƒ}.) In this manner Value at Risk computations can be carried out for risk factor distributions which are a perturbation on a multivariate normal distribution. As before, the identity above would be used simultaneously for all c, and smoothing may be used to further improve the overall accuracy of the estimated distribution.

It is worth noting here also that it is particularly fast and simple to re-calculate the saddlepoint approximations that we have discussed when the variance-covariance matrix is changed only by a constant multiple, say from Σ to s²Σ, where s is a positive scaling quantity. Under this change, H changes to sH, while a₂ and B2 change to sa₂ and s²B₂ respectively. The matrix P of column-bound eigenvectors for the new B₂ remains unchanged, but the diagonal matrix Λ of eigenvalues changes to s²Λ. Hence overall, the new representation for (8) involves aⱼ's that are s times larger., and λⱼ's that are s² times larger. These quantities can therefore be obtained essentially without additional computational labour, and hence so can the associated transform quantities, M_{Y}(t), K(t), and so on. Indeed, the new version of the function K(t) at (11) can be obtained from the old version, simply by replacing its argument t by s²t, and by dividing the second term on the right in (11) by s². In this and related ways, one can obtain the saddlepoint approximations for a large number of rescalings of the variance-covariance matrix Σ.

One of many applications of the foregoing method is to quite general scale mixtures of a given multivariate normal distribution. As an example, we consider the centered multivariate t distribution having ν degrees of freedom. For illustration, let us consider such a distribution generated by dividing a multivariate Nₖ(0, Σ) distributed vector X by a common random scaling factor S, where S has a distribution related to the chi-squared distribution having ν degrees of freedom, more specifically, where S has the distribution of \sqrt{X_{ν}²/ν} and is independent of X. The appropriate version of (8) in this case becomes

$$Y {=}^{d} {\sum }_{j = 1}^{k} ( \frac{{a}_{j} {Z}_{j}}{S} + \frac{{λ}_{j} {Z}_{j}^{2}}{{S}^{2}} ) . \qquad ( 23 )$$

The moment generating function of this quantity may in fact be computed quite easily. One way to do this is to first write down the bivariate moment generating function of the two component variables of (8), namely the variables (U, V) where U=ΣaⱼZⱼ and V=ΣλⱼZⱼ². This can be done quite easily, since each value of this bivariate MGF is in fact just a specialized instance of the earlier univariate MGF. Thus we obtain

$$\begin{matrix}{M}_{U , V} ( t , u ) = {Ee}^{tU + uV} \\ = {\{ {\prod }_{j = 1}^{k} ( 1 - 2 {λ}_{j} u ) \}}^{- 1 / 2} \times exp \{ \frac{1}{2} {\sum }_{j = 1}^{k} \frac{{a}_{j}^{2 } {t}^{2}}{1 - 2 {λ}_{j} {u}^{2}} \} ,\end{matrix} \qquad ( 24 )$$

and the MGF corresponding to (23) is then given by

$${M}_{1} ( t ) = {\int }_{0}^{∞} {M}_{U , V} ( \frac{t}{s} , \frac{t}{{s}^{2}} ) h ( s ) ⅆ s \qquad ( 25 )$$

where h(s) is the density function for S which is readily determined. Mixture MGF's of this type can readily be computed either analytically or computationally, and can be used in the usual ways in conjunction with the other methods we have given herein. For many scale-mixture distributions h(S), mgf's of the type (25) can readily be computed either analytically or computationally. If the scale-mixture distribution h(s) is such that Mₗ(t) is not finite (as happens, for instance, if we try to produce a multivariate t-distribution in this way) then the computations at (25) can still be carried out provided characteristic functions are used instead of moment generating functions; the resulting characteristic function can then be inverted by Fourier methods.

As additional applications of our method for using mixtures of normal distributions, we note that convolutions are a special case of mixtures. Consequently, if the distribution of the risk factors is taken to be the sum of a multivariate normally distributed random vector and an independent random vector having any distribution whatsoever, then our method may be applied to the individual component multivariate normal distributions in the convolution mixture that arises, and the resulting saddlepoint approximations can then be averaged, as before, in accordance with the mixture's distribution. An important special case of this applies to nonparametric kernel density estimates with multivariate normal kernel. Such distributions are just convolutions of the multivariate normal kernel with the empirical distribution of a multivariate data set. Therefore such nonparametric kernel density estimates are mixtures of multivariate normal distributions, the number of terms in the mixture equaling the number of multivariate observations in the data set.

Some Computational Steps for Implementing the Invention.

We outline here some of the computational steps involved in implementing our algorithm for a delta-gamma portfolio (i.e. a portfolio that has been quadratically approximated) under a given multivariate normal distribution for risk factors.

Step 0. The vector a₁, and the matrix B₁ are given by prior art. If the given B₁ is not symmetric, we symmetrize it. The process of determining the delta-gamma portfolio quantities a₁ and B₁ may be automated in a variety of ways. For example, if a formula or a computer subroutine is available for determining the gains or losses of the portfolio as a function of the values of the risk factors, then the quantities a₁ and B₁ may be determined or estimated automatically by numerical methods which determine the appropriate Taylor approximation quantities, namely the gradient and the Hessian of the function. The variance-covariance matrix Σ of the multivariate normal distribution for the risk factor returns is given by prior art.

Step 1. Carry out a factorization of the variance-covariance matrix Σ in the form Σ=HH′. This can be done in many ways; for example we may choose to do a Cholesky factorization.

Step 2. Compute the symmetric matrix B₂=H′B₁H.

Step 3. Compute the singular value decomposition B₂=PΛP′ of this matrix.

Step 4. Determine the vector a=P′H′a₁.

Step 5. Numerically determine the cumulant generating function for the delta-gamma gamma quadratic form in the multivariate normal variates, as well as its first two derivatives.

Step 6. Plug this cumulant generating function and its derivatives into the saddlepoint approximation using standard numerical methods. This will result in an estimated cumulative distribution function for the portfolio's gains or losses.

Step 7. Determine the value at risk from the quantiles of this estimated cumulative distribution function at the required probability level(s) using standard numerical procedures.

In the case that higher than quadratic order approximations are used for the overall portfolio pricing function, the first four or more cumulants of such random approximating functions are computed by means of the Leonov-Shiryaev formula (which allows computation of multivariate cumulants of sums of products of random variables). These cumulants are then used to build a Taylor (i.e. polynomial) approximation to the cumulant generating function, or to correct the first few terms of the cumulant generating function obtained by the delta-gamma approximation. These cumulant generating functions are used instead as input to the saddlepoint approximation as outlined above at Step 6.

Note that the eigenvalues of B₂=H′B₁H are in fact the same as those of B₁Σ or ΣB₁, because in general, commuted matrices AB and BA have the same eigenvalues.

Many variants on these basic computational steps will suggest themselves to persons skilled in these arts.

The present invention has been described in terms of particular embodiments. It will be appreciated by those of skill in the art that, in light of the present disclosure, numerous modifications and changes can be made in the particular embodiments exemplified without departing from the intended scope of the invention. All such modifications are intended to be included within the scope of the appended claims.

All publications, patents and patent applications are incorporated by reference in their entirety to the same extent as if each individual publication, patent or patent application was specifically and individually indicated to be incorporated by reference in its entirety.

References:

Andrews, D. F., Fraser, D. A. S. and Wong, A. (2000). Higher order Laplace integration and the hyperaccuracy of recent likelihood methods. Submitted for publication.

Arvanitis, A., Browne, C., Gregory, J. and Martin, R. (1998). A credit risk toolbox. Risk, December 1998, 50-55.

Barndorff-Nielsen, O. E. (1986). Inference on full or partial parameters based on the standardized signed log likelihood ratio. Biometrika, 73, 307-322.

Barndorff-Nielsen, O. E. (1991). Modified signed log likelihood ratio. Biometrika, 78, 557-563.

Barndorff-Nielsen, O. E. and Cox, D. R. (1979). Edgeworth and saddlepoint approximations with statistical applications (with discussions). J. Royal Statist. Soc. B, 41, 279-312.

Barndorff-Nielsen, O. E. and Cox, D. R. (1989). Asymptotic Techniques for Use in Statistics. Chapman and Hall, N.Y.

Barndorff-Nielsen, O. E. and Cox, D. R. (1994). Inference and Asymptotics. Chapman and Hall, N.Y.

Brillinger, D. R. (1975). Time Series: Data Analysis and Theory. Holt, Rinehart and Winston, N.Y.

Campbell, J. Y., Lo, A. W. and MacKinlay; A. C. (1 997). The Econometrics of Financial Markets. Princeton University Press.

Cardenas, J., Fruchard, E., Koehler, E., Michel, C. and Thomazeau, I. (1997). VaR: One step beyond. Risk, 10, No. 10, October 1997.

Daniels, H. E. (1980). Exact saddlepoint approximations. Biometrika, 67,59-63.

Daniels, H. E. (1987). Tail probability approximations. Int. Statist. Rev., 55, 37-48.

Davison, A. and Hinkley, D. (1988). Saddlepoint approximations in resampling methods. Biometrika, 75,417-431.

Duffie, D. and Pan, J. (1999). Analytical Value at Risk with jumps and credit risk. Working paper, Graduate School of Business, Stanford University, Nov. 29, 1999.

Feuerverger, A. (1989). On the empirical saddlepoint approximation. Biometrika, 76, 357-364.

Feuerverger, A. and McDunnough, P. (1981). On efficient inference in symmetric stable laws and processes. In: Proceedings of the International Symposium on Statistics and Related Topics. (Csorgo, Dawson, Rao and Saleh, Eds.) Pages 109-122. North Holland Publishing Co., Amsterdam.

Fraser, D. A. S., Wong, A. C. M. and Wu, J. (1998). An approximation for the noncentral chi-squared distribution. Commun. Statist.—Simulation, 27, 275-287.

Fuglsbjerg, B. (2000). Variance reduction techniques for Monte Carlo estimates of Value at Risk. Working paper. Financial Research Dept., SimCorp A/S, Copenhagen, Denmark.

P. Glassermann, P. Heidelberger and P. Shahabuddin. (1999). Stratification issues in estimating value-at-risk. IBM Research Report in Computer Science/Mathematics, RC 21548 (97174).

Hampel, F. (1974). Some small sample asymptotics. Proc. of the Prague Symp. on Asymp. Statist., Charles Univ., Prague, 1973. Vol 2, pp 109-126.

Hull, J. C. (1998). Introduction to Futures and Options Markets. Prentice Hall

Hull, J. C. (1989). Options, Futures, and Other Derivative Securities. Prentice Hall.

Jensen, J. L. (1995). Saddlepoint Approximations. Oxford University Press.

Jorion, P. (1996). Risk²: measuring the risk in Value at Risk. Financial Analysts Journal, 52, 47-56.

Jorion, P. (1997). Value at Risk. McGraw-Hill, New York.

Lugannani, R. and Rice, S. (1980). Saddlepoint approximation for the distribution of the sum of independent random variables. Adv. in Appl. Probab., 12, 475-490.

Mathai, A. M. and Provost, S. B. (1 992). Quadratic forms in random Variables, Theory and Applications. Marcel Dekker, New York.

Mina, J. and Ulmer, A. (1999). Delta-gamma four ways. RiskMetrics Inc. (Available recently from the RiskMetrics web-site.)

B. Oksendal (1998). Stochastic Differential Equations. An Introduction with Applications. Springer-Verlag.

Pichler, s. and Selitsch, K. (2000). A comparison of analytical and VaR methodologies for portfolios that include options. In: Model Risk, Concepts, Calibration, and Pricing, R. Gibson, ed., 252-265. Risk Books, London.

Reid, N. (1988). Saddlepoint methods in statistical inference. Statist. Sci., 3, 213-238.

Reid, N. (1996). Likelihood and higher order approximations to tail areas: A review and annotated bibliography. Canad. J. Statist., 24, 141-166.

Rice, S O (1980), Distribution of quadratic forms in normal variables—Evaluation by numerical integration. SLAM Journal of Scientific and Statistical Computing, 1, 438-448.

RiskMetrics Technical Document, 4^{th} ed. Morgan Guarantee Trust Company, 1996.

RiskMetrics—Technical Document, J. P. Morgan/Reuters, 1996. (Updated versions of this document have been issued also)

L. C. G. Rogers and O. Zane (1999). Saddlepoint approximations to options prices. Annals of Applied Probability, 9, 493-503.

Ronchetti, E. and Field, C. (1990). Small Sample Asymptotics. Institute of Mathematical Statistics Lecture Notes. Hayward, Calif.

Rouvinez, C. (1997). Going greek with VaR. Risk, 10, No. 2, February 1997.

Feuerverger, A. and Wong, A. (2000). Computation of Value-at-Risk for Nonlinear Portfolios. Journal of Risk, Vol.3, No.1, 37-55.

I claim:

1. A method of determining the risk in possessing a portfolio having a portfolio price and a portfolio return, the portfolio including holdings each having a holding return, the holdings having been mapped to risk factors for which the parameters of a multivariate normal statistical distribution have been determined, the method including:
expressing each holding return as a quadratic form in the returns of the risk factors;
aggregating the quadratic forms in the holdings to obtain a quadratic form approximation for the portfolio;
determining a cumulant generating function of the quadratic form in the portfolio return and the first and second derivatives of the cumulant generating function;
inputting the cumulant generating function and the derivatives into a saddlepoint approximation of first order or higher order from which the statistical distribution function of the portfolio return is provided, and
providing a Value at Risk quantity from a tail area of the statistical distribution function of the portfolio return.

2. The method of claim 1, wherein the wherein the holdings comprise financial instruments.

3. The method of claim 1 or 2, wherein the quadratic form is a function which is a sum of a first part and a second part, the first part including a linear term in the risk factor returns; the second part including a quadratic term in the risk factor returns.

4. The method of any of claims 1 to 3, wherein the cumulant generating function is obtained from a transform including a characteristic function or a moment generating function of the statistical distribution of the quadratic form.

5. The method of any of claims 1 to 4, comprising determining a cumulant generating function of the quadratic form in the portfolio return and its first, second and/or higher derivatives.

6. The method of any of claims 1 to 5, wherein the cumulant generating function is determined from a Laplace transform, a Fourier transform, a Mellin transform, or a probability generating function.

7. The method of any of claims 1 to 6, wherein the saddlepoint approximation includes a Lugannani and Rice saddlepoint approximation, a Barndorff-Nielsen saddlepoint approximation, a Rice saddlepoint approximation, a Daniels saddlepoint approximation, or a higher order saddlepoint approximation.

8. The method of any of claims 1 to 7, wherein the portfolio return is expressed as a sum of two functions, the first term of which is a linear term, a quadratic term or a sum thereof, and the second term being a residual term.

9. The method of any of claims 1 to 8, further comprising Monte Carlo trials to determine the Value at Risk.

10. The method of any of claims 1 to 9, wherein the quadratic form is determined from a pricing formula for derivative securities.

11. The method of claim 10, wherein the pricing formula comprises a Black and Scholes formula, a Cox-Ingersol-Ross formula, a Heath-Morton-Jarrow formula, a binomial pricing formula or a Hull-White formula.

12. The method of any of claims 1 to 9, wherein the quadratic form is determined analytically or numerically with the gradient and/or Hessian of a function or of a computing program which determines the return or the price of the portfolio.

13. The method of any of claims 1 to 12, wherein the method is performed with a computer.

14. A value at risk provided in accordance with any of claims 1 to 13.

15. A system for determining the risk in possessing a portfolio having a portfolio return and a portfolio price, the portfolio including holdings each having a holding return the holdings having been mapped to risk factors (i) for which the multivariate normal distribution has been determined or (ii) for which the parameters of a discrete or continuous mixture of multivariate normal distributions has been determined, the method including:
a) means for expressing each holding return as a quadratic form in the returns of the risk factors;
b) means for aggregating the quadratic forms in the holdings to obtain a quadratic form approximation for the overall portfolio;
c) means for determining a cumulant generating function of the quadratic form in the portfolio return and the first and second derivatives of the cumulant generating function; and
d) means for inputting the cumulant generating function and the derivatives into a saddlepoint approximation of first order or higher order from which the statistical distribution function of the portfolio return is provided,
wherein a Value at Risk quantity can be provided from a tail area of the statistical distribution function of the portfolio return.

16. The system of claim 15, wherein the wherein the holdings comprise financial instruments.

17. The system of claim 15 or 16, wherein the quadratic form is a function which is a sum of a first part and a second part, the first part including a linear term in the risk factor returns; the second part including a quadratic term in the risk factor returns.

18. The system of any of claims 15 to 17, wherein the cumulant generating function is obtained from a transform including a characteristic function or a moment generating function of the statistical distribution of the quadratic form.

19. The system of any of claims 15 to 18, comprising means for determining a cumulant generating function of the quadratic form in the portfolio return and the first, second and/or higher derivatives.

20. The system of any of claims 15 to 19, wherein the cumulant generating function is determined from a Laplace transform, a Fourier transform, a Mellin transform, or a probability generating function.

21. The system of any of claims 15 to 20, wherein the saddlepoint approximation includes a Lugannani and Rice saddlepoint approximation, a Barndorff-Nielsen saddlepoint approximation, a Rice saddlepoint approximation, a Daniels saddlepoint approximation, or a higher order saddlepoint approximation.

22. The system of any of claims 15 to 21, wherein the portfolio return is expressed as a sum of two functions, the first term of which is a linear term, a quadratic term or a sum thereof, and the second term being a residual term.

23. The system of any of claims 15 to 22, further comprising Monte Carlo trials to determine the Value at Risk.

24. The system of any of claims 15 to 23, wherein the quadratic form is determined from a pricing formula for derivative securities.

25. The system of claim 24, wherein the pricing formula comprises a Black and Scholes formula, a Cox-Ingersol-Ross formula, a Heath-Morton-Jarrow formula, a binomial pricing formula or a Hull-White formula.

26. The system of any of claims 15 to 23, wherein the quadratic form is determined analytically or numerically with the gradient and/or Hessian of a function or of a computing program which determines the return or price of the portfolio.

27. The system of any of claims 15 to 26, wherein the method is performed with a computer.

28. A value at risk provided in accordance with any of claims 15 to 27.

29. A method of determining the risk in possessing a portfolio having a portfolio return and a portfolio price, the portfolio including holdings each having a holding return, the holdings having been mapped to risk factors for which the parameters of a discrete or continuous mixture of multivariate normal distributions has been determined, the method including:
expressing each holding return as a quadratic form in the returns of the risk factors;
aggregating the quadratic forms in the holdings to obtain a quadratic form approximation for the portfolio;
determining a cumulant generating function of the quadratic form in the portfolio return and the first and second derivatives of the cumulant generating function;
inputting the cumulant generating function and the derivatives into a saddlepoint approximation of first order or higher order from which the statistical distribution function of the portfolio return is provided, and
providing a Value at Risk quantity from a tail area of the statistical distribution function of the portfolio return.

30. The method of claim 29, wherein the mixture of multivariate normal distributions includes a convolution and/or a kernel density estimator.

31. The method of claim 29 or 30, wherein the wherein the holdings comprise financial instruments.

32. The method of any of claims 29 to 31, wherein the quadratic form is a function which is a sum of a first part and a second part, the first part including a linear term in the risk factor returns; the second part including a quadratic term in the risk factor returns.

33. The method of any of claims 29 to 32, wherein the cumulant generating function is obtained from a transform including a characteristic function or a moment generating function of the statistical distribution of the quadratic form.

34. The method of any of claims 29 to 33, comprising determining a cumulant generating function of the quadratic form in the portfolio return and the first, second and/or higher derivatives.

35. The method of any of claims 29 to 34, wherein the cumulant generating function is determined from a Laplace transform, a Fourier transform, a Mellin transform, or a probability generating function.

36. The method of any of claims 29 to 35, wherein the saddlepoint approximation includes a Lugannani and Rice saddlepoint approximation, a Barndorff-Nielsen saddlepoint approximation, a Rice saddlepoint approximation or a Daniels saddlepoint approximation, or a higher order saddlepoint approximation.

37. The method of any of claims 29 to 36, wherein the portfolio return is expressed as a sum of two functions, the first term of which is a linear term, a quadratic term or a sum thereof, and the second term being a residual term.

38. The method of any of claims 29 to 37, wherein the quadratic form is determined from a pricing formula for derivative securities.

39. The method of claim 38, wherein the formula comprises a Black and Scholes formula a Cox-Ingersol-Ross formula, a Heath-Morton-Jarrow formula, a binomial pricing formula or a Hull-White formula.

40. The method of any of claims 29 to 37, wherein the quadratic form is determined analytically or numerically with the gradient and/or Hessian of a function or of a computing program which determines the return of the portfolio return.

41. The method of any of claims 29 to 40, further comprising Monte Carlo trials to determine the Value at Risk.

42. The methods of any of claims 29 to 41, wherein the method is performed with a computer.

43. A value at risk provided in accordance with any of claims 29 to 42.

44. A method of determining the risk in possessing a portfolio having a portfolio return, the portfolio including holdings each having a holding return, the holdings having been mapped to risk factors for which the parameters of a multivariate normal statistical distribution have been determined, the method including:
expressing each holding return as an expanded polynomial of the third or higher order in the returns of the risk factors;
aggregating the multivariate polynomials for the holdings to obtain a multivariate form approximation for the portfolio return;
determining a predetermined number of the first cumulants of the expanded polynomial;
determining a cumulant generating function of the expanded polynomial in the portfolio return using the first cumulants;
determining the first and second derivatives of the cumulant generating function;
inputting the cumulant generating function and first and second derivatives into a saddlepoint approximation of first order or higher order from which the statistical distribution function of the portfolio return is provided, and
providing a Value at Risk quantity from a tail area of the statistical distribution function of the portfolio return.

45. The method of claim 44, wherein the holdings comprise financial instruments.

46. The method of any of claims 44 and 45, wherein at least four of the first cumulants are determined.

47. The method of any of claims 44 to 46, wherein the pre-determined number of the first cumulants are determined by applying a method which comprises the Leonov-Shiryaev formula for multivariate cumulants of products of random variables.

48. The method of any of claims 44 to 46, wherein the pre-determined number of the first cumulants are determined from an empirical distribution of the collection of historical data of the returns of the risk factors during a pre-determined time period.

49. The method of any of claims 44 to 46, wherein the pre-determined number of the first cumulants are determined from the convolution of a kernel function with an empirical distribution of the collection of historical data of the returns of the risk factors during a pre-determined time period.

50. The method of any of claims 44 to 49, wherein the cumulant generating function of the expanded polynomial is approximated by constructing a truncated power series using the first cumulants as coefficients.

51. The method of any of claims 44 to 50, wherein the cumulant generating function of the expanded polynomial is approximated by a method comprising:
approximating each holding return as a quadratic form in the returns of the risk factors;
aggregating the quadratic forms in the holdings to obtain a quadratic form approximation for the portfolio;
determining a cumulant generating function of the quadratic form in the portfolio and a pre-determined number of the first derivatives of the cumulant generating function of the quadratic form;
determining a pre-determined number of the first coefficients of the Taylor series expansion of the cumulant generating function of the quadratic form using the derivatives of the cumulant generating function of the quadratic form of order one to the number of cumulants.
approximating the cumulant generating function of the expanded polynomial as the sum of the cumulant generating function of the quadratic form and a polynomial with coefficients equal to the differences between the cumulants as determined from the quadratic form and as determined from the coefficients of the Taylor series expansion.

52. The method of claim 51, wherein the quadratic form is a function which is a sum of a first part and a second part, the first part including a linear term in the risk factor returns; the second part including a quadratic term in the risk factor returns.

53. The method of any of claims 51 or 52, wherein the cumulant generating function of the quadratic form is obtained from a transform including a characteristic function or a moment generating function of the statistical distribution of the quadratic form.

54. The method of any of claims 51 to 53, comprising determining a cumulant generating function of the quadratic form in the portfolio return and its first, second and/or higher derivatives.

55. The method of any of claims 51 to 54, wherein the cumulant generating function of the quadratic form is determined from a Laplace transform, a Fourier transform, a Mellin transform, or a probability generating function.

56. The method of any of claims 51 to 55, wherein the portfolio return is expressed as a sum of two functions, the first term of which is a linear term, a quadratic term or a sum thereof, and the second term being a residual term.

57. The method of any of claims 51 to 56, wherein the saddlepoint approximation includes a Lugannani and Rice saddlepoint approximation, a Barndorff-Nielsen saddlepoint approximation, a Rice saddlepoint approximation, a Daniels saddlepoint approximation, or a higher order saddlepoint approximation.

58. The method of any of claims 51 to 57, wherein the quadratic form is determined from a pricing formula for derivative securities.

59. The method of claim 58, wherein the pricing formula comprises a Black and Scholes formula, a Cox-Ingersol-Ross formula, a Heath-Morton-Jarrow formula, a binomial pricing formula or a Hull-White formula.

60. The method of any of claims 51 to 57, wherein the quadratic form is determined analytically or numerically with the gradient and/or Hessian of a function or of a computing program which determines the return of the portfolio.

61. The method of any of claims 44 to 60, further comprising Monte Carlo trials to determine the Value at Risk.

62. The method of any of claims 44 to 61, wherein the coefficients of the multivariate polynomial, being the Taylor expansion, of the portfolio return are obtained by summing the coefficients of multivariate polynomials of holding returns.

63. The method of any of claims 44 to 61, wherein the coefficients of the multivariate polynomial, being the Taylor expansion, of the portfolio return are obtained by averaging the coefficients of multivariate polynomials of holding returns.

64. The method of any of claims 44 to 63, wherein the coefficients of multivariate polynomials of holding returns are obtained by computing the holding return and its derivatives.

65. The method of any of claims 44 to 64, wherein the method is implemented by a computer.

66. A value at risk provided in accordance with any of claims 44 to 65.

67. A system of determining the risk in possessing a portfolio having a portfolio return, the portfolio including holdings each having a holding return, the holdings having been mapped to risk factors for which the parameters of a multivariate normal statistical distribution have been determined, the system including:
means for expressing each holding return as an expanded polynomial of the third or higher order in the returns of the risk factors;
means for aggregating the multivariate polynomials for the holdings to obtain a multivariate form approximation for the portfolio return;
means for determining a pre-determined number of the first cumulants of the expanded polynomial;
means for determining a cumulant generating function of the expanded polynomial in the portfolio return using the first cumulants;
means for determining the first and second derivatives of the cumulant generating function;
means for inputting the cumulant generating function and first and second derivatives into a saddlepoint approximation of first order or higher order from which the statistical distribution function of the portfolio return is provided, and
means for providing a Value at Risk quantity from a tail area of the statistical distribution function of the portfolio return.

68. The system of claim 67, wherein the holdings comprise financial instruments.

69. The system of any of claims 67 and 68, wherein at least four of the first cumulants are determined.

70. The system of any of claims 67 to 69, comprising means for determining the predetermined number of the first cumulants by applying the Leonov-Shiryaev formula for multivariate cumulants of products of random variables.

71. The system of any of claims 67 to 69, comprising means for determining the predetermined number of the first cumulants from an empirical distribution of the collection of historical data of the returns of the risk factors during a predetermined time period.

72. The system of any of claims 67 to 69, comprising means for determining the predetermined number of the first cumulants from the convolution of a kernel function with an empirical distribution of the collection of historical data of the returns of the risk factors during a pre-determined time period.

73. The system of any of claims 67 to 72, comprising means for determining the cumulant generating function of the expanded polynomial by an approximation by constructing a truncated power series using the first cumulants as coefficients.

74. The system of any of claims 67 to 72, comprising means for determining the cumulant generating function of the expanded polynomial by an approximation by:
approximating each holding return as a quadratic form in the returns of the risk factors;
aggregating the quadratic forms in the holdings to obtain a quadratic form approximation for the portfolio;
determining a cumulant generating function of the quadratic form in the portfolio and a pre-determined number of the first derivatives of the cumulant generating function of the quadratic form;
determining a pre-determined number of the first coefficients of the Taylor series expansion of the cumulant generating function of the quadratic form using the derivatives of the cumulant generating function of the quadratic form of order one to the number of cumulants.
approximating the cumulant generating function of the expanded polynomial as the sum of the cumulant generating function of the quadratic form and a polynomial with coefficients equal to the differences between the cumulants as determined from the quadratic form and as determined from the coefficients of the Taylor series expansion.

75. The system of claim 74, wherein the quadratic form is a function which is a sum of a first part and a second part, the first part including a linear term in the risk factor returns; the second part including a quadratic tern in the risk factor returns.

76. The system of any of claims 74 to 75, comprising means for determining the cumulant generating function of the quadratic form from a transform including a characteristic function or a moment generating function of the statistical distribution of the quadratic form.

77. The system of any of claims 74 to 75, comprising means for determining a cumulant generating function of the quadratic form in the portfolio return and its first, second and/or higher derivatives.

78. The system of any of claims 74 to 77, comprising means for determining the cumulant generating function of the quadratic form from a Laplace transform, a Fourier transform, a Mellin transform, or a probability generating function.

79. The system of any of claims 74 to 78, wherein the portfolio return is expressed as a sum of two functions, the first term of which is a linear term, a quadratic term or a sum thereof, and the second term being a residual term.

80. The system of any of claims 74 to 78, wherein the saddlepoint approximation includes a Lugannani and Rice saddlepoint approximation, a Barndorff-Nielsen saddlepoint approximation, a Rice saddlepoint approximation, a Daniels saddlepoint approximation, or a higher order saddlepoint approximation.

81. The system of any of claims 74 to 80, wherein the quadratic form is determined from a pricing formula for derivative securities.

82. The system of any of claims 81, wherein the pricing formula comprises a Black and Scholes formula, a Cox-Ingersol-Ross formula, a Heath-Morton-Jarrow formula, a binomial pricing formula or a Hull-White formula.

83. The system of any of claims 74 to 80, wherein the quadratic form is determined analytically or numerically with the gradient and/or Hessian of a function or of a computing program which determines the return of the portfolio.

84. The system of any of claims 67 to 83, wherein the coefficients of the multivariate polynomial, being the Taylor expansion, of the portfolio return are obtained by summing the coefficients of multivariate polynomials of holding returns.

85. The system of any of claims 67 to 83, wherein the coefficients of the multivariate polynomial, being the Taylor expansion, of the portfolio return are obtained by averaging the coefficients of multivariate polynomials of holding returns.

86. The system of any of claims 67 to 85, wherein the coefficients of multivariate polynomials of holding returns are obtained by computing the holding return and its derivatives.

87. The system of any of claims 67 to 86, further comprising Monte Carlo trials to determine the Value at Risk.

88. A value at risk provided in accordance with any of claims 67 to 87.
